(19) United States
(12) Patent Application Publication
(10) Pub. No.: US 2005/0020476 A1
(43) Pub. Date: Jan. 27, 2005

(54) Softening-through-the-wash composition and process of manufacture

(75) Inventors: Errol Hoffman Wahl, Cincinnati, OH (US); Adrian John Waynforth Angell, West Chester, OH (US); Fiona Susan Williams, Newcastle upon Tyne (GB); Nathalie Sophie Letzelter, Newcastle upon Tyne (GB); Barbara Kay Williams, West Chester, OH (US); Gary Wayne Keitel, West Harrison, IN (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/864,236

(22) Filed: Jun. 9, 2004

Related U.S. Application Data
(60) Provisional application No. 60/479,258, filed on Jun. 18, 2003.
(60) Provisional application No. 60/478,066, filed on Jun. 12, 2003.

(51) Int. Cl. C11D 7/42

(52) U.S. Cl. 510/515

(57) ABSTRACT

Softening-through-the-wash compositions (“STW compositions”) are added to the wash cycle of a laundering process to soften fabrics. The STW compositions of the present invention comprise a particulate fabric softening active having an average particle size of less than about 800 microns in diameter. The STW compositions are substantially free of detersive surfactants and silicone materials. The STW compositions can further comprise a particulate co-softening compound having an average particle size of less than about 800 microns in diameter. The STW compositions comprise an effective amount of the particulate fabric softening active and optional particulate co-softening compound to provide a concentration of the fabric softening active and optional co-softening compound of at least about 50 parts per million when the STW composition is dispensed in a wash solution of the laundering process. Processes to make these STW compositions are also encompassed in the present invention.

### CROSS REFERENCE

This application claims the benefit of U.S. Provisional Application No. 60/479,258, filed Jun. 18, 2003, which claims the benefit of U.S. Provisional Application No. 60/478,066, filed Jun. 12, 2003, hereby incorporated herein by reference.

### FIELD OF INVENTION

The present invention relates to softening-through-the-wash compositions (hereinafter referred to as “STW compositions”) and processes of manufacturing such compositions.

### BACKGROUND OF THE INVENTION

Conventional fabric softening compositions are added in the rinse cycle of the laundering process to soften fabrics. However, adding such compositions during the rinse cycle can be inconvenient for the consumer, unless the consumer has a laundry washing machine that has a built-in fabric softener dispensing unit, a removable agitator post-mounted fabric softener dispenser, or has a fabric softener dosing device such as the DOWNY® Ball. Otherwise, the consumer has to monitor the laundering process and then manually add the fabric softener to the load as soon as the rinse cycle begins.

STW compositions are able to soften fabrics and provide freshness and antistatic benefits to fabric while being added to the fabrics in the laundering process during the washing stage, negating the need to add a separate fabric-conditioning composition to the rinse stage and/or drying stage of the laundering process. The STW compositions can thus be added to the load of laundry at the beginning of the laundering process, which provides the consumer with an efficient and easy way to soften fabric during the laundering process.

It is convenient to provide fabric softening compositions in the form of a unit dose. Previous attempts have been made to provide a unit dose fabric softening composition in the form of a tablet. However, such tablets tend to leave an undesirable visible residue on the treated fabrics, are suitable only for addition in the rinse cycle, and/or provide only insignificant fabric softening benefits. See, e.g., U.S. Pat. No. 6,291,421 and U.S. Pat. No. 6,110,886.

There has thus been a need to provide a softening-through-the-wash composition that provides effective deposition of a fabric softening active on the treated fabrics to provide a consumer noticeable softening benefit, while avoiding the deposition of a visible residue on the treated fabrics.

### SUMMARY OF THE INVENTION

The present invention relates to STW compositions that are added to the wash cycle of a laundering process to soften fabrics. The STW compositions of the present invention comprise a particulate fabric softening active having an average particle size of less than about 800 microns in diameter. The STW compositions are substantially free of detersive surfactants and silicone materials. The STW compositions can further comprise a particulate co-softening compound having an average particle size of less than about 800 microns in diameter. The STW compositions comprise an effective amount of the particulate fabric softening active and optional particulate co-softening compound to provide a concentration of the fabric softening active and optional co-softening compound of at least about 50 parts per million when the STW composition is dispensed in a wash solution of the laundering process. Processes to make these STW compositions are also encompassed in the present invention.

The STW compositions of the present invention are able to provide an effective amount of fabric softening active on the treated fabrics to provide improved softening performance, while minimizing any visible residue left on the treated fabrics.

All documents cited are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

### DETAILED DESCRIPTION OF THE INVENTION

Fabric Softening Active

The present compositions comprise a fabric softening active, including mixtures of fabric softening actives. Typical minimum levels of incorporation of the fabric softening active in the present compositions are at least about 2%, preferably at least about 5%, more preferably at least about 10%, and even more preferably at least about 12%, by weight of the composition, and the typical maximum levels of incorporation of the fabric softening active in the present compositions are less than about 90%, preferably less than about 70%, by weight of the composition. In preferred embodiments, the present compositions comprise fabric softening active at a level of from about 10% to about 95%, and more preferably from about 40% to about 95%, by weight of the composition.

Preferred Diester Quaternary Ammonium (DEQA) Compounds

The fabric softening active herein can preferably be a DEQA compound. The DEQA compounds encompass a description of diamido fabrics softener actives as well as fabric softener actives with mixed amido and ester linkages.

A first type of DEQA (“DEQA (1)”) suitable as a fabric softening active in the present compositions includes compounds of the formula:
{R₄₋ₘ—N⁺—[(CH₂)ₙ—Y—R₁]ₘ}X⁻
wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂₋₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R1, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X⁻ can be any softener-compatible anion, preferably, chloride, bromide, methylsulfate, ethylsulfate, sulfate, phosphate, and nitrate, more preferably chloride or methyl sulfate. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids, e.g., oleic acid, and/or partially hydrogenated fatty acids, derived from vegetable oils and/or partially hydrogenated vegetable oils, such as, canola oil, safflower oil, high oleic safflower oil, peanut oil, sunflower oil, corn oil, soybean oil, tall oil, rice bran oil, etc. Non-limiting examples of suitable fatty acids are listed in U.S. Pat. No. 5,759,990 at column 4, lines 45-66. Those skilled in the art will recognized that materials made from such process can comprise a combination of mono-, di-, and tri-esters depending on the process and the starting materials. Materials from this group preferred for the present invention include those comprising a high level of diester content, preferably more than 70% of the total active weight and more preferably at least about 80% of the total active weight (as used herein, the “percent of softener active” containing a given R¹ group is based upon taking a percentage of the total active based upon the percentage that the given R¹ group is, of the total R¹ groups present.). Non-limiting examples of preferred diester quats for the present invention include N,N-di(tallowoyloxyethyl)-N,N-dimethylammonium chloride (available from Akzo under the trade name Armosoft® DEQ) and N,N-di(canola-oyloxyethyl)-N,N-dimethylammonium chloride (available from Degussa under the trade name Adogen® CDMC). Nonlimiting examples of available TEA ester quats suitable for the present invention include di-(hydrogenated tallowoyloxyethyl)-N,N-methylhydroxyethylammonium methylsulfate and di-(oleoyloxyethyl)-N,N-methylhydroxyethylammonium methylsulfate sold under the trade names Rewoquat® WE 15 and Varisoft® WE 16, both available from Degussa.

Additional preferred DEQA (1) actives include compounds comprising different Y structures such as the those having the structure below where one Y=—C(O)—O— and the other Y=—NH—C(O)—:
R¹—C(O)O—R²—N⁺(R⁴)ₙ—R³—N(H)—C(O)—R¹X⁻
wherein n is 1 or 2; R¹ is a C₆-C₂₂, preferably a C₈-C₂₀, hydrocarbyl group or substituted hardrocarbyl groups that are branched or unbranched and saturated or unsaturated; R² and R³ are each C₁-C₅, preferably C₂-C₃, alkyl or alkylene groups; and R⁴ is H, or a C₁-C₃ alkyl or hydroxyalkyl group. Non-limiting example of such softeners are N-tallowoyloxyethyl-N-tallowoylaminopropyl methyl amine and N-tallowoyloxyethyl-N-tallowoylaminopropyl methyl ammonium chloride. Additional non-limiting examples of such softeners are described in U.S. Pat. No. 5,580,481 and U.S. Pat. No. 5,476,597.

Other suitable fabric softening actives include reaction products of fatty acids with dialkylenetriamines in, e.g., a molecular ratio of about 2:1, said reaction products containing compounds of the formula:
R¹—C(O)—NH—R²—NH—R₃—NH—C(O)—R¹
wherein R¹, R² are defined as above, and each R³ is a C₁₋₆ alkylene group, preferably an ethylene group. Examples of these fabric softening actives are reaction products of tallow acid, canola acid, or oleic acids with diethylenetriamine in a molecular ratio of about 2:1, said reaction product mixture containing N,N″-ditallowoyldiethylenetriamine, N,N″-dicanolaoyldiethylenetriamine, or N,N″-dioleoyldiethylenetriamine, respectively, with the formula:
R¹—C(O)—NH—CH₂CH₂—NH—CH₂CH₂—NH—C(O)—R¹
wherein R² and R³ are divalent ethylene groups, R¹ is defined above and an acceptable examples of this structure when R¹ is the oleoyl group of a commercially available oleic acid derived from a vegetable or animal source, include Emersol® 223LL or Emersol® 7021, available from Henkel Corporation.

Another fabric softening active for use in the present compositions has the formula:
[R¹—C(O)+NR—R²—N(R)₂—R³—NR—C(O)—R¹]⁺X⁻
wherein R, R¹, R², R³ and X⁻ are defined as above. Examples of this fabric softening active are the di-fatty amidoamines based softener having the formula:
[R¹—C(O)—NH—CH₂CH₂—N(CH₃)(CH₂CH₂OH)—CH₂CH₂—NH—C(O)—R¹]⁺CH₃SO₄⁻
wherein R¹—C(O) is an oleoyl group, soft tallow group, or a hardened tallow group available commercially from Degussa under the trade names Varisoft® 222LT, Varisoft® 222, and Varisoft® 110, respectively.

A second type of DEQA (“DEQA (2)”) compound suitable as a fabric softening active in the present compositions has the general formula:
[R₃N⁺CH₂CH(YR¹)(CH₂YR¹)]X⁻
wherein each Y, R, R¹, and X⁻ have the same meanings as before. Such compounds include those having the formula:
[CH₃]₃ N⁽⁺⁾[CH₂CH(CH₂O(O)CR¹)O(O)CR¹]Cl⁽⁻⁾
wherein each R is a methyl or ethyl group and preferably each R¹ is in the range of C₁₅ to C₁₉. As used herein, when the diester is specified, it can include the monoester that is present. The amount of monoester that can be present is the same as in DEQA (1).

These types of agents and general methods of making them are disclosed in U.S. Pat. No. 4,137,180, Naik et al., issued Jan. 30, 1979, which is incorporated herein by reference. An example of a preferred DEQA (2) is the “propyl” ester quaternary ammonium fabric softener active having the formula 1,2-di(acyloxy)-3-trimethylammoniopropane chloride.

While it is acceptable for the present invention for the composition to contain a number of softening actives, including other fabric softening actives disclosed herein below, the DEQA fabric softening actives, and specifically those fabric softener actives with two ester linkages, are preferred fabric softening actives for the present invention.

Other Fabric Softening Actives

Instead of, or in addition to, the DEQA fabric softening actives described hereinbefore, the present compositions can also comprise a variety of other fabric softening actives. These other suitable fabric softening actives include:

(1) compounds having the formula:
[R₄₋ₘ—N⁽⁺⁾—R¹_{m]A}⁻
wherein each m is 2 or 3, each R¹ is a C₆-C₂₂, preferably C₁₄-C₂₀, but no more than one being less than about C₁₂ and then the other is at least about 16, hydrocarbyl, or substituted hydrocarbyl substituent, preferably C₁₀-C₂₀ alkyl or alkenyl (unsaturated alkyl, including polyunsaturated alkyl, also referred to sometimes as “alkylene”), most preferably C₁₂-C₁₈ alkyl or alkenyl, and branched or unbranched. Each R is H or a short chain C₁-C₆, preferably C₁-C₃ alkyl or hydroxyalkyl group, e.g., methyl (most preferred), ethyl, propyl, hydroxyethyl, and the like, benzyl, or (R² O)₂₋₄H where each R² is a C₁₋₆ alkylene group; and A⁻ is a softener compatible anion, preferably, chloride, bromide, methylsulfate, ethylsulfate, sulfate, phosphate, or nitrate; more preferably chloride or methyl sulfate. Examples of these fabric softening actives include dialkydimethylammonium salts and dialkylenedimethylammonium salts such as ditallowdimethylammonium chloride, dicanoladimethylammonium chloride, and dicanoladimethylammonium methylsulfate. Examples of commercially available dialkylenedimethylammonium salts usable in the present invention are di-hydrogenated tallow dimethyl ammonium chloride, ditallowdimethyl ammonium chloride, and dioleyldimethylammonium chloride available from Degussa under the trade names Adogen® 442, Adogen® 470, and Adogen® 472, respectively.

(2) compounds having the formula: 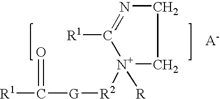
wherein each R, R¹, and A⁻ have the definitions given above; each R² is a C₁₋₆ alkylene group, preferably an ethylene group; and G is an oxygen atom or an —NR— group. Examples of this fabric softening active are 1-methyl-1-tallowylamidoethyl-2-oleylimidazolinium methylsulfate and 1-methyl-1-oleylamidoethyl-2-oleylimidazolinium methylsulfate wherein R¹ is an acyclic aliphatic C₁₅-C₁₇ hydrocarbon group, R² is an ethylene group, G is a NH group, R⁵ is a methyl group and A⁻ is a methyl sulfate anion, available commercially from Degussa under the trade names Varisoft® 475 and Varisoft® 3690, respectively.

(3) compounds having the formula: 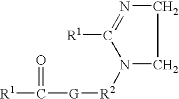
wherein R¹, R² and G are defined as above. An example of this fabric softening active is 1-oleylamidoethyl-2-oleylimidazoline wherein R¹ is an acyclic aliphatic C₁₅-C₁₇ hydrocarbon group, R² is an ethylene group, and G is a NH group.

(4) reaction products of substantially unsaturated and/or branched chain higher fatty acid with hydroxyalkylalkylenediamines in a molecular ratio of about 2:1, said reaction products containing compounds of the formula:
R¹—C(O)—NH—R²—N(R³OH)—C(O)—R¹
wherein R¹, R² and R³ are defined as above. Examples of this fabric softening active are reaction products of fatty acids such as tallow fatty acid, oleic fatty acid, or canola fatty acid with N-2-hydroxyethylethylenediamine in a molecular ratio of about 2:1, said reaction product mixture containing a compound of the formula:
R¹—C(O)—NH—CH₂CH₂—N(CH₂CH₂OH)—C(O)—R¹
wherein R¹—C(O) is oleoyl, tallowyl, or canola-oyl group of a commercially available fatty acid derived from a vegetable or animal source. Nonlimiting examples of such actives include Emersol® 223LL or Emersol® 7021, which are derived from oleic acid and available from Henkel Corporation.

(5) compounds having the formula: 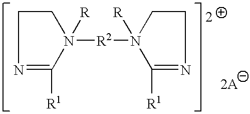
wherein R, R¹, R², and A⁻ are defined as above.

Other compounds suitable as fabric softening actives herein are acyclic quaternary ammonium salts having the formula:
[R¹—N(R⁵)₂—R⁶]⁺A⁻
wherein R⁵ and R⁶ are C₁-C₄ alkyl or hydroxyalkyl groups, and R¹ and A⁻ are defined as herein above. Examples of these fabric softening actives are the monoalkyltrimethylammonium salts and the monoalkenyltrimethylammonium salts such as monotallowyltrimethylammonium chloride, monostearyltrimethylammonium chloride, monooleyltrimethylamrnmonium chloride, and monocanolatrimethylammonium chloride. Commercial examples include tallowtrimetylammonium chloride and soyatrimethylammonium chloride available from Degussa under the trade names Adogen® 471 and Adogen® 415.

(6) substituted imidazolinium salts having the formula: 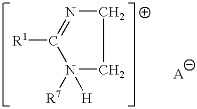
wherein R⁷ is hydrogen or a C₁-C₄ saturated alkyl or hydroxyalkyl group, and R¹ and A⁻ are defined as hereinabove;

(7) substituted imidazolinium salts having the formula: 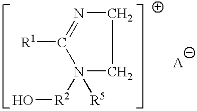
wherein R⁵ is a C₁-C₄ alkyl or hydroxyalkyl group, and R¹, R², and A⁻ are as defined above;

(8) alkylpyridinium salts having the formula: 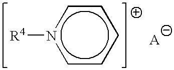
wherein R⁴ is an acyclic aliphatic C₈-C₂₂ hydrocarbon group and A⁻ is an anion. An example of this fabric softening active is 1-ethyl-1-(2-hydroxyethyl)-2-isoheptadecylimidazolinium ethylsulfate wherein R¹ is a C₁₋₇ hydrocarbon group, R² is an ethylene group, R⁵ is an ethyl group, and A⁻ is an ethylsulfate anion.

(9) alkanamide alkylene pyridinium salts having the formula: 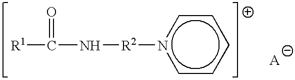
wherein R¹, R² and A⁻ are defined as herein above; and mixtures thereof.

Other suitable fabric softening actives for use in the present compositions include pentaerythritol compounds. Such compounds are disclosed in more detail in, e.g., U.S. Pat. No. 6,492,322 U.S. Pat. No. 6,194,374; U.S. Pat. No. 5,358,647; U.S. Pat. No. 5,332,513; U.S. Pat. No. 5,290,459; U.S. Pat. No. 5,750,990, U.S. Pat. No. 5,830,845 U.S. Pat. No. 5,460,736 and U.S. Pat. No. 5,126,060.

Polyquaternary ammonium compounds can also be useful as fabric softening actives in the present compositions and are described in more detail in the following patent documents: EP 803,498; GB 808,265; GB 1,161,552; DE 4,203,489; EP 221,855; EP 503,155; EP 507,003; EP 803,498; FR 2,523,606; JP 84-273918; JP 2-011,545; U.S. Pat. No. 3,079,436; U.S. Pat. No. 4,418,054; U.S. Pat. No. 4,721,512; U.S. Pat. No. 4,728,337; U.S. Pat. No. 4,906,413; U.S. Pat. No. 5,194,667; U.S. Pat. No. 5,235,082; U.S. Pat. No. 5,670,472; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. The products formed by quaternization of reaction products of fatty acid with N,N,N′,N′, tetraakis(hydroxyethyl)-1,6-diaminohexane are also suitable for use in the present invention.

Examples of ester and/or amide linked fabric softening actives useful in the present invention, are disclosed in U.S. Pat. No. 5,759,990 and U.S. Pat. No. 5,747,443.

Examples of suitable amine softeners that can be used in the present invention as fabric softening actives are disclosed in copending U.S. application Ser. No. 09/463,103, filed Jul. 29, 1997, by Grimm et al., now allowed.

Other fabric softening actives that can be used herein are disclosed, at least generically for the basic structures, in U.S. Pat. No. 3,861,870; U.S. Pat. No. 4,308,151; U.S. Pat. No. 3,886,075; U.S. Pat. No. 4,233,164; U.S. Pat. No. 4,401,578; U.S. Pat. No. 3,974,076; and U.S. Pat. No. 4,237,016. Examples of more biodegradable fabric softeners can be found in U.S. Pat. No. 3,408,361; U.S. Pat. No. 4,709,045; U.S. Pat. No. 4,233,451; U.S. Pat. No. 4,127,489; U.S. Pat. No. 3,689,424; U.S. Pat. No. 4,128,485; U.S. Pat. No. 4,161,604; U.S. Pat. No. 4,189,593; and U.S. Pat. No. 4,339,391.

The fabric softening active in the present compositions is preferably selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)-2-hydroxyethyl ammonium methyl sulfate, methyl bis(hydrogenated tallow amidoethyl)-2-hydroxyethyl ammonim methyl sulfate, methyl bis (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

It will be understood that all combinations of fabric softening actives disclosed above are suitable for use in this invention.

In one embodiment of the present invention, the STW-composition comprises a fabric softening active that is a quaternary ammonium component having the formula: 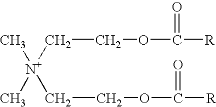
wherein, each R is independently selected from C₁₂-C₂₂ alkyl groups; the quaternary ammonium component being in combination with a source of acid selected from the group consisting of C₁₂-C₂₂ fatty acids, mono-alkyl esters of a C₁₂-C₂₂ alkyl sulphuric acids, C₁₁-C₁₃ alkyl benzene sulphonic acids, anionic derivatives thereof, salts thereof, and mixtures thereof, preferably stearic acid. This combination is described in detail in co-pending U.S. application Ser. No. 10/310,432 filed Dec. 5, 2002 (P&G Case CM2635). The IV of the fatty acid precursor for the quaternary ammonium compound is from about 0 to about 60, preferably from about 0 to about 40, and more preferably from about 0 to about 25. A preferred combination is a 1:1 mole ratio of the quaternary compound and stearic acid.

In another embodiment of the present invention, the STW composition is free of such a combination of quaternary ammonium compound and a source of acid described in the previous paragraph.

Co-Softening Compound

The present STW compositions can optionally further comprise a co-softening compound to enhance the fabric softening performance of the composition. The co-softening compound can be comprised of many fatty-based materials. When present, the co-softening compounds are typically incorporated in the STW compositions at a level of from about 0.5% to about 50%, preferably from about 1% to about 25%, and more preferably from about 3% to about 20%, by weight of the composition. Preferred co-softening compounds are C₁₂-C₂₂ fatty acids, with palmitic acid or stearic acid being especially preferred.

C₁₂-C₂₂ fatty acids can be represented by the formula:
R₁—COOH,
wherein, R₁ is a C₁₁-C₂₁ alkyl group. Salts of fatty acids can be represented by the formula:
R₁—COO⁻M⁺,
wherein, M⁺ is an alkali metal ion, preferably Na⁺ and/or K⁺, and R₁ is a C₁₁-C₂₁ alkyl group. Anionic derivatives of fatty acids can be represented by the formula
R₁—COO⁻,
wherein, R₁ is a C₁₁-C₂₁ alkyl group.

Preferred sources of C₁₂-C₂₂ fatty acids are selected from the group consisting of: lauric acid, tridecylic acid, myristic acid, pentadecylic acid, palmitic acid, margaric acid, stearic acid, arachidic acid, phytanic acid, behenic acid, anionic derivatives thereof, salts thereof, and combinations thereof. Most preferably, the source of acid is stearic acid.

Preferred sources of acid are C₁₂-C₂₂ fatty acids comprising a saturated alkyl group. Other preferred sources of acids are C₁₂-C₂₂ fatty acids comprising an unsaturated group, typically having an iodine value of from about 0 to 25.

The source of acid may be selected from the group consisting of palmitoleic acid, oleic acid, elaidic acid, vaccenic acid, linoleic acid, cis-eleostearic acid, trans-eleostearic acid, linolenic acid, arachidonic acid, salts thereof, and combinations thereof.

Preferred sources of fatty acids are selected from the group consisting of coconut, soybean, tallow, palm, palm kernel, rapeseed, lard, sunflower, corn, safflower, canola, olive, peanut, and combinations thereof. A highly preferred source of fatty acid is tallow. Preferred fatty acids have a cis:trans isomer ratio of from about 0 to 200:1, preferably from about 0.1:1 to about 10:1. A preferred source of acid is hard tallow fatty acid and/or partially hydrogenated tallow fatty acid.

It is not necessary to co-melt and/or co-mix the co-softening compound with the fabric softening active, but there can be processing, handling, and other advantages for forming a co-melt of these ingredients during processing. Other useful co-softening compounds include stearyl dimethylamine, distearyl amine, fatty alcohols (preferably stearyl alcohol and palmityl alcohol and mixtures), fatty esters, fatty amides, fatty ester amides, natural triglycerides such as tallow, canola oil, sunflower oil, and oleyl triglycerides, hydrocarbons, paraffins, or fatty amine/acid ion pairs. A particular effective ion pair, especially for static control, is the reaction product of distearylamine and cumene sulfonic acid. The best particle size for the distearylamine/cumene sulfonic ion pair is from about 30 microns to about 150 microns.

Clay

The present STW compositions can optionally, but preferably, comprise clay. The STW compositions will typically comprise from about 5% to about 80%, preferably from about 10% to about 75%, and more preferably from about 15% to about 70%, by weight of the composition, of clay.

Preferably, the weight ratio of clay to fabric softening active is from 0.5:1 to 20:1, preferably from 1:1 to 20:1, or from 1:1 to 10:1, or preferably greater than 1:1, or even greater than 2:1. Preferably, the weight ratio of clay to the optional co-softening compound is from 1:1 to 50:1, preferably from 5:1 to 50:1, or preferably greater than 5:1. Preferably, the weight ratio of clay to the combined weight of the fabric softening active and optional co-softening compound is from 0.1:1 to 10:1, preferably from 1:1 to 5:1, or preferably greater than 1:1.

Typically, the clay is selected from the group consisting of: allophane clays; chlorite clays, preferred chlorite clays are amesite clays, baileychlore clays, chamosite clays, clinochlore clays, cookeite clays, corundophite clays, daphnite clays, delessite clays, gonyerite clays, nimite clays, odinite clays, orthochamosite clays, pannantite clays, penninite clays, rhipidolite clays, sudoite clays and thuringite clays; illite clays; inter-stratified clays; iron oxyhydroxide clays preferred iron oxyhydoxide clays are hematite clays, goethite clays, lepidocrite clays and ferrihydrite clays; kaolin clays, preferred kaolin clays are kaolinite clays, halloysite clays, dickite clays, nacrite clays and hisingerite clays; smectite clays; vermiculite clays; and mixtures thereof.

Preferably, the clay is a smectite clay. Preferred smectite clays are beidellite clays, hectorite clays, laponite clays, montmorillonite clays, nontonite clays, saponite clays, or mixtures thereof. Preferably, the smectite clay may be a dioctahedral smectite clay. A preferred dioctahedral smectite clay is montmorillonite clay. The montmorillonite clay may be low-charge montmorillonite clay (also known as sodium montmorillonite clay or Wyoming-type montmorillonite clay). Typically, low-charge montmorillonite clay can be represented by the formula:
NaₓAl₂₋ₓMgₓSi₄O₁₀(OH)₂,
wherein, x is a number from 0.1 to 0.5, preferably from 0.2, and preferably to 0.4.

The montmorillonite clay may also be a high-charge montmorillonite clay (also known as a calcium montmorillonite clay or Cheto-type montmorillonite clay). Typically, high-charge montmorillonite clays can be represented by the formula:
CaₓAl₂₋ₓMgₓSi₄O₁₀(OH)₂,
wherein, x is a number from 0.1 to 0.5, preferably from 0.2, and preferably to 0.4.

Preferably, the smectite clay is a trioctahedral smectite clay. A preferred trioctahedral smectite clay is hectorite clay. Typically, hectorite clay can be represented by the following formula:
[(Mg₃₋ₓLiₓ)Si_{4-y}Me^{III}_{y}O₁₀(OH_{2-z}F_{z})]^{-(x+y)}((x+y)/n)Mⁿ⁺,
wherein: y=0 to 0.4, if y=>0 then Me^{III} is AL, Fe or B, preferably y=0; and n is 1 or 2; and Mⁿ⁺ is a monovalent (n=1) or a divalent (n=2) metal ion, preferably Mⁿ⁺ is selected from the group Na, K, Mg, Ca and Sr; and x is a number from 0.1 to 0.5, preferably from 0.2, or from 0.25, and preferably to 0.4, or to 0.35; and z is a number form 0 to 2; and the value of x+y is the layer charge of the hectorite clay, preferably the value of x+y is from 0.1 to 0.5, preferably from 0.2, or from 0.25, and preferably to 0.4 or to 0.35.

Preferred hectorite clays have a cationic exchange capacity of at least 90 meq/100 g. Typically, the cationic capacity of clays are measured by the method described in Grimshaw, The Chemistry and Physics of Clays, 1971, Interscience Publishers Inc., pages 264-265. Especially preferred Hectorite clays are supplied by Rheox, and sold under the tradenames “Hectorite U” and “Hectorite R”.

The clay may be a light-colored crystalline clay mineral, preferably having a reflectance of at least 60, more preferably at least 70, or at least 80 at a wavelength of 460 nm. Typically, the average particle size of the light coloured crystalline clay mineral particles should not exceed 2 μm, especially preferably not exceeding 1 μm. The average particle size of the light coloured crystalline clay mineral particles is typically measured using a Malvern Zetasizer™, using a dispersion of the light coloured crystalline clay at 0.1 g/l in deionised water, the clay being dispersed by vigorous agitation for 1 minute. Preferred light coloured crystalline clay minerals are china clays, halloysite clays, dioctahedral clays such as kaolinite, trioctahedral clays such as antigorite and amesite, smectite and hormite clays such as bentonite (montmorillonite), beidilite, nontronite, hectorite, attapulgite, pimelite, mica, muscovite and vermiculite clays, as well as pyrophyllite/talc, willemseite and minnesotaite clays. Preferred light coloured crystalline clay minerals are described in GB 2,357,523 A and WO 01/44425.

The clay, in combination with the fabric softening active and optional co-softening compound, gives a surprising fabric softening performance, ease of ironing benefit, reduces creasing of fabric, confers an ease of ironing benefit to fabric, confers an anti-static benefit to fabric, reduces the fading of color from fabric, confers a skin moisturizing benefit to fabric and improves the soil removal performance of the STW-composition. The clay can also act as a tableting aid to allow tablet breakup and dispersion and as a carrier for the fabric softener actives, especially particulate actives that are sticky and have difficulty flowing, or for more liquid and semi-solid actives. The clay also acts as a good carrier for perfume oils to help make free-flowing granules.

Hydrophobically Modified Cellulose

The present STW compositions can optionally further comprise hydrophobically modified cellulose, typically at a level effective to provide a concentration of the hydrophobically modified cellulose in the wash solution of a laundering process of from about 4 parts per million to about 50 parts per million. These hydrophobically modified cellulose materials can render the treated fabrics easier to iron after laundering. However, if the hydrophobically modified cellulose is dispensed in the wash solution at too high of a level, the treated fabrics can have undesirable fabric feel and/or stiffness. Typically, the compositions will comprise hydrophobically modified cellulose at a level of from about 0.5% to about 5%, preferably from about 1% to about 4%, and more preferably from about 2% to about 3%, by weight of the composition. Preferred hydrophobically modified cellulosic polymers for incorporation in the present STW compositions have the general formula: 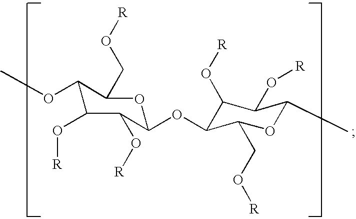
wherein each R is selected from the group consisting of R₂, R_{c}, and 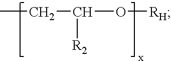
wherein:
each R₂ is independently selected from the group consisting of H and C₁-C₄ alkyl;
each R_{c} is 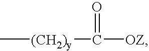
wherein each Z is independently selected from the group consisting of M, R₂, R_{c}, and RH;
each RH is independently selected from the group consisting of C₅-C₂₀ alkyl, Cs-C₇ cycloalkyl, C₇-C₂₀ alkylaryl, C₇-C₂₀ arylalkyl, substituted alkyl, hydroxyalkyl, C₁-C₂₀ alkoxy-2-hydroxyalkyl, C₇-C₂₀ alkylaryloxy-2-hydroxyalkyl, (R₄)₂N-alkyl, (R₄)₂N-2-hydroxyalkyl, (R₄)₃ N-alkyl, (R₄)₃ N-2-hydroxyalkyl, C₆-C₁₂ aryloxy-2-hydroxyalkyl, 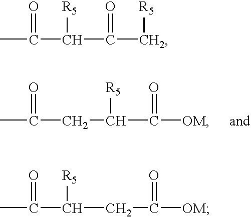
each R₄ is independently selected from the group consisting of H, C₁-C₂₀ alkyl, C₅-C₇ cycloalkyl, C₇-C₂₀ alkylaryl, C₇-C₂₀ arylalkyl, aminoalkyl, alkylaminoalkyl, dialkylaminoalkyl, piperidinoalkyl, morpholinoalkyl, cycloalkylaminoalkyl and hydroxyalkyl;
each R₅ is independently selected from the group consisting of H, C₁-C₂₀ alkyl, Cs-C₇ cycloalkyl, C₇-C₂₀ alkylaryl, C₇-C₂₀ arylalkyl, substituted alkyl, hydroxyalkyl, (R₄)₂N-alkyl, and (R₄)₃ N-alkyl;
   wherein:
M is a suitable cation selected from the group consisting of Na, K, ½Ca, and ½Mg;
each x is from 0 to about 5;
each y is from about 1 to about 5; and
   provided that:
the Degree of Substitution for group RH is between about 0.001 and 0.1, more preferably between about 0.005 and 0.05, and most preferably between about 0.01 and 0.05;
the Degree of Substitution for group R_{c} wherein Z is H or M is between about 0.2 and 2.0, more preferably between about 0.3 and 1.0, and most preferably between about 0.4 and 0.7;
if any R_{H} bears a positive charge, it is balanced by a suitable anion; and
two R₄'s on the same nitrogen can together form a ring structure selected from the group consisting of piperidine and morpholine.

These hydrophobically modified cellulosic polymers are described in detail in U.S. Pat. No. 6,384,011. Suitable hydrophobically modified cellulose materials are available from Noviant under the trade name FINNIFIX®.

Coating Material

Preferred coating materials include those selected from the group consisting of adipic acid, carboxylic acid, dicarboxylic acid, polyvinyl acetate (PVA), polyvinyl pyrrolidone (PVP), polyacetic acid, polyethylene glycol (PEG), polyvinyl alcohol (PVOH), and mixtures thereof. Preferred carboxylic or dicarboxylic acids preferably comprise an even number of carbon atoms. Preferred carboxylic or dicarboxylic acids comprise at least 4, more preferably at least 6, even more preferably at least 8 carbon atoms, most preferably between 8 and 13 carbon atoms. Preferred dicarboxylic acids include adipic acid, suberic acid, azelaic acid, subacic acid, undecanedioic acid, dodecanedioic acid, tridecanedioic and mixtures thereof. Adipic acid is especially preferred as a coating material for the present STW compositions. When present, a coating material is generally incorporated in the present compositions at a level of from about 0.1% to about 30%, preferably from about 3% to about 20%, and more preferably from about 5% to about 15%, by weight of the STW composition.

Disrupting Agent

When the STW compositions of the present invention are in the form of a unit dose tablet, the compositions can optionally further comprise a disrupting agent. Disrupting agents are typically included in the composition at levels of from about 5% to about 60%, and more preferably from about 10% to about 20%, by weight. The disrupting agent can be a disintegrating agent or an effervescing agent. Suitable disintegrating agents include agents that swell on contact with water or facilitated water influx and/or efflux by forming channels in compressed and/or non-compressed portions. Any known disintegrating or effervescing agent suitable for use in laundry or dishwashing applications is envisaged for use herein. Examples of suitable disintegrating agents include starch, starch derivatives, alginates, carboxymethylcellulose (CMC), sodium acetate, or aluminium oxide. Suitable effervescing agents are those that produce a gas on contact with water, such as oxygen, nitrogen dioxide or carbon dioxide evolving species. Examples of suitable effervescing agents include perborate, percarbonate, carbonate (such as sodium carbonate), bicarbonate, or carboxylic acids (such as citric acid or maleic acid). Mixtures of disrupting agents are also preferred.

Perfume

The STW compositions of the present invention can optionally further comprise perfume, typically at a level of from about 0.1% to about 10%, preferably from about 1% to about 5%, and more preferably from about 1% to about 3%, by weight of the composition. Preferably, the perfume comprises enduring perfume ingredients that have a boiling point of about 250° C. or higher and a ClogP of about 3.0 or higher, more preferably at a level of at least about 25%, by weight of the perfume. Suitable perfumes, perfume ingredients, and perfume carriers are described in detail in co-pending U.S. application Ser. No. 09/838,867 filed Apr. 20, 2001 (P&G Case 8079M).

Dye

The STW compositions can optionally further comprise a dye to impart color to the composition. If present, a dye is preferably comprised in a coating material. A suitable dye for the present STW compositions is FD&C Blue #1.

The STW compositions of the present composition can optionally further comprise other ingredients selected from the group consisting of bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents for fabrics and skin, sun fade inhibitors, insect repellents, anti-allergenic agents, enzymes, water proofing agents, fabric comfort agents, water conditioning agents, shrinkage resistance agents, stretch resistance agents, and mixtures thereof.

The STW compositions of the present invention are preferably free of detersive surfactants and silicone materials. Detersive surfactants are surfactants that are present in a composition in an amount effective to provide soil removal from fabrics. Typical detersive surfactants include anionic surfactants, such as alkyl sulfates and alkyl sulfonates, and nonionic surfactants, such as C₈-C₁₈ alcohols condensed with from 1 to 9 moles of C₁-C₄ alkylene oxide per mole of C₈-C₁₈ alcohol.

The STW compositions of the present invention are preferably in the form of a solid composition. Solid compositions include powders, granules, noodles, flakes, bars, tablets, or mixtures thereof. The STW composition can also be in the form of a liquid, paste, gel, suspension, or any mixture thereof. Preferably, the STW composition is in the form of a solid composition, most preferably a particulate solid composition. Typically, the STW composition has a bulk density of from 300 g/l to 1500 g/l, preferably from 600 g/l to 900 g/l. Preferably, the STW composition has a size diameter average particle size of the particular fabric softening active and optional co-softening compound of less than about 800 microns, preferably between about 1 micron and 500 microns, more preferably between about 1 micron and about 150 microns, and even more preferably between about 10 microns and about 100 microns. When the fabric softening active and co-softening compound are admixed or agglomerated with other formula components to form granules (for example, clays, carbonates, acids, and/or hydrophobically modified cellulose) the granule particle size is less than about 2000 microns, preferably from about 200 microns to about 2000 microns, and more preferably from about 300 microns to 600 microns.

The STW compositions of the present invention, when added to a wash solution of a laundering process, provide a concentration of at least about 50 ppm, preferably at least about 100 ppm, and more preferably from about 150 ppm to about 500 ppm, of fabric softening active and optional co-softening compound in the wash solution. Applicants have found that these levels are preferred to provide an effective level of particulate disposition to provide a noticeable softness benefit. Higher softener concentrations could provide more softness, but could also result in visible particulates on fabrics and possible staining or spotting. A typical wash solution of a laundering process has a volume of about 65 liters.

The STW compositions of the present invention can be added directly, as-is, to the wash cycle, preferably as a unit dose composition. It is preferred that the compositions be pressed into a tablet form as a convenient unit dose. Tablets can be spherical, square, rectangle, or disc-like. The STW compositions can be contained in a coating material comprising a film, either water-soluble or water insoluble, to form unit doses of the STW composition. It is preferred that the film of the coating material be water-soluble, preferably made of polyvinyl alcohol or a derivative of polyvinyl alcohol. Water-insoluble films can also be used, such as polyethylene and the like.

When a STW composition contained in a coating material comprising a film is desired, these materials may be obtained in a film or sheet form that may be cut to a desired shape or size. Specifically, it is preferred that films of polyvinyl alcohol, hydroxypropyl methyl cellulose, methyl cellulose, non-woven polyvinyl alcohols, PVP and gelatins or mixtures be used to encapsulate the STW compositions. Polyvinyl alcohol films are commercially available from a number of sources including Chris Craft Industrial Products Inc., of Gary, Ind., Nippon Synthetic Chemical Industry Co. Ltd. Of Osaka Japan, and Ranier Specialty Chemicals of Yakima, Washington. These films may be used in varying thicknesses ranging from about 20 to about 80 microns, preferably from about 25 to about 76 microns. For purposes of the present invention, it is preferred to use a film having a thickness of about 25 to about 76 micrometers for rapid dissolution in a cold water wash. Where larger volumes of composition are to be contained in encapsulate, volumes exceeding about 25 ml, a thicker film may be desired to provide additional strength and integrity to the encapsulate. Further, it is preferred that the water-soluble films be printable and colored as desired.

Encapsulate articles such as pouches, pillows, sachets, beads, or envelopes are easily manufactured by heat-sealing multiple sheets together at their edges, leaving an opening for inserting the STW composition. This opening can then be heat-sealed after the STW composition has been introduced. The size of the film segments used will depend on the volume of composition to be encapsulated. Heat sealing is described as a preferred method for forming and sealing encapsulated articles of the present invention, but it should be recognized that the use of adhesives, mechanical bonding, and partially solvating the films are alternative preferred methods for forming encapsulated articles.

### Process of Manufacture

The present invention further encompasses processes for manufacturing the STW compositions of the present invention. A preferred process comprises the steps of applying heat and/or pressure to the STW composition and forming particles having an average diameter of less than about 800 microns from the softening-through-the-wash composition using a technique selected from the group consisting of extrusion, prilling, agglomeration, and combinations thereof.

Prilling is an operation in which a melted material (i.e., liquid) is atomized into small droplets and changed to small solid particles (prills) by removing the heat associated with the phase change. Usually, a solid material is heated above its melting point, followed by pressure, pneumatic, of disk atomization into small molten droplets. The liquid melt is normally sprayed into a tower with a flow of cold air to promote solidification on the droplets into prills. The cold air provides the driving force by removing the sensible and latent heat (fusion or hydration) from the droplet and changes its phase to solid.

Powders or granules of the fabric softening active can also be prepared by cryo-grinding. If a mixture of actives is desired, for example, a mixture of a quaternary ammonium compound and a fatty acid, then the components of the mixture are preferably first melted and then mixed together until uniform. The mixture is then allowed to cool. The cooled solid single active or mixture of active is admixed with dry ice in a ratio of about one part active to one part dry ice. This admix is then placed in a grinder, for example, a food processor, blender, or a coffee bean mill. The admix is ground for about one minutes or until a fine particle size is achieved. The resulting powder is screened through a 150 mesh metal screen. Dry ice can be added to the screen to help prevent sticking and screen blinding. The fine particles passing through the screen are used in making the fabric softener compositions that provide softening and static benefits when added in the wash cycle of the laundry process.

### EXAMPLES

The following Examples 1-7 are non-limiting examples of granular/particulate STW compositions of the present invention.

| | EXAMPLE | | | | | | |
|---|---|---|---|---|---|---|---|
| Ingredient | 1 | 2 | 3 | 4 | 5 | 6 | 7 |
| N,N-di(tallowoyloxyethyl)- | — | 11.9% | 13.1% | — | 13.5% | 51.4% | 21.4% |
| N,N-dimethylammonium | | | | | | | |
| chloride | | | | | | | |
| Stearic Acid | — | 3.6% | 3.9% | — | 4.0% | 15.3% | 6.4% |
| Di-(tallowoyloxyethyl)-N,N- | 32.9% | — | — | — | — | — | — |
| methylhydroxyethylammonium | | | | | | | |
| methylsulfate | | | | | | | |
| C₁₆-C₁₈ Fatty Acid | 21.8% | — | — | 20.0% | — | — | — |
| Stearyl Dimethylamine | 7.6% | — | — | — | — | — | — |
| Clay ^{a} | 4.0% | — | — | — | — | — | — |
| Non-gelling Clay ^{b} | 27.6% | 56.1% | 61.9% | 27.8% | 63.9% | 27.8% | 66.7% |
| N,N-di(tallowoyloxyethyl)- | — | — | — | 46.7% | — | — | — |
| N,N-dimethylammonium | | | | | | | |
| methyl sulfate | | | | | | | |
| Sodium Carbonate | — | 7.0% | 7.7% | — | 8.0% | — | — |
| Citric Acid | — | 7.0% | 7.7% | — | 8.0% | — | — |
| Hydrophobically Modified | 2.8% | 2.3% | 2.6% | | 2.6% | 2.8% | 2.8% |
| Cellulose ^{c} | | | | 2.8% | | | |
| Perfume | 2.8% | 2.3% | 2.6% | 2.2% | — | 2.2% | 2.2% |
| Dye (FD&C Blue #1) | 0.5% | 0.5% | 0.5% | 0.5% | — | 0.5% | 0.5% |
| Adipic Acid | — | 9.3% | — | — | — | — | — |

^{a} Calcium bentonite clay, BENTOLITE ® L, available from Southern Clay Products.
^{b} Non-gelling bentonite clay available from Cohn Stewart Minchem LTD (UK).
^{c} Ester modified carboxymethyl cellulose available from Noviant under the trade name FINNIFIX ®.

### Examples 8-14

Examples 8-14 are each unit dose STW compositions in the form of tablets. To make Examples 8-14, about 38 grams of each granular STW composition of Examples 1-7, respectively, are formed into a tablet having a density of about 1100 grams/liter using a 40 mm×40 mm square shaped die punch and a laboratory press available under the trade name Carver Model 3912.

### Example 15

This exemplifies a process of the present invention to make 36.2 grams of the STW composition of Example 1. The following materials are mixed in a Cuisinart brand food processor: 1.3 grams of di-(tallowoyloxyethyl)-N,N-methylhydroxyethylammonium methylsulfate, 7.9 grams of C₁₆-C₁₈ fatty acid, 2.7 grams of stearyl dimethylamine, 1.4 grams of bentonite clay, 10.0 grams of non-gelling bentonite clay (from Colin Stewart Minchem Ltd.), 1.0 gram of FINNIFIX®, 1.0 gram of perfume, and 0.2 grams of dye (FD&C Blue #1). The resultant mixture is granulated by passing the mixture through a low pressure extrusion process, using a multi-hole die plate in which the die hole diameter is 750 microns. The resulting extruded particles are ground and screened to an average particle length of 1.5 millimeters.

The resulting particulate composition is then optionally formed into a tablet having a density of 1100 grams/liter using a 40 millimeter×40 millimeter square shaped die punch and a laboratory press available under the trade name Carver Model 3912.

### Example 16

The exemplifies a process of the present invention to make a coated tablet STW composition of the present invention. The ingredients of the STW composition of Example 2 (minus the adipic acid) of are mixed in a Cuisinart brand food processor. The resultant mixture is granulated by passing the mixture through a low pressure extrusion process, using a multi-hole die plate in which the die hole diameter is 750 microns. The resulting extruded particles are ground and screened to an average particle length of 1.5 millimeters.

The resulting particulate composition is then formed into a tablet having a density of 1100 grams/liter using a 40 millimeter×40 millimeter square shaped die punch and a laboratory press available under the trade name Carver Model 3912.

A coating material is separately prepared by melting adipic acid at a temperature of 145° C. The tablets are then coated with the adipic acid coating material by dipping the tablets into the molten coating material for 3 seconds.

### Example 17

The exemplifies a STW composition of the present invention contained in a coating material comprising a polyvinyl alcohol film. A polyvinyl alcohol film, Monosol 8630 having a thickness of 76 microns, is provided in a first rectangular sheet and a vacuum is pulled on the film to create a depression in the film. The depression is then filled with a granular STW composition of Example 5. A second rectangular sheet of the film is provided and applied over the first rectangular sheet of film, and then heat sealed to form a unit dose STW composition contained in a polyvinyl alcohol film.

### Example 18

This exemplifies another STW composition contained in a coating material comprising a polyvinyl alcohol film. This example is the same as Example 17, except that a different film, Monosol 7030 having a thickness of 76 microns, is used to contain a granular STW composition of Example 6.

### Example 19

This exemplifies another STW composition contained in a coating material comprising a polyvinyl alcohol film. This example is the same as Example 17, except that a different film, Monosol 8630 having a thickness of 38 microns, is used to contain a granular STW composition of Example 7.

### Example 20

This exemplifies a process for making a STW composition of Example 1. First, 625 grams of a first mixture consisting of 79.5% of di-(tallowoyloxyethyl)-N,N-methylhydroxyethylammonium methylsulfate and 20.5% of C₁₆-C₁₈ fatty acid is melted with stirring in a water bath at 82° C. Then 312.5 grams of a second mixture consisting of 36.65% of stearyl dimethylamine and 45.5% of C₁₆-C₁₈ fatty acid is added to the first mixture and stirred to form a homogeneous third mixture. Then 62.5 grams of non-gelling bentonite clay (from Colin Steward Minchem Ltd.) is added to the third mixture, then heated and stirred to form a homogeneous fourth mixture. The fourth mixture is poured onto aluminum foil, cooled, and broken into 2 to 3 inch pieces for grinding. The pieces are placed in a Cuisinart brand food processor containing equal parts of dry ice and the pieces ground into coarse granules. The coarse granules are then transferred to a blender with equal parts of dry ice and then ground into fine granules. The fine granules are then sieved through a 150-mesh stainless steel screen. Then 24 grams of the sieved fine granules are mixed in a Cuisinart brand food processor with 10 grams of non-gelling bentonite clay (from Colin Steward Minchem Ltd.), 1 gram of FINNIFIX®, 1 gram of perfume, and 0.2 gram of dye until homogeneous and then screened through a 150-mesh stainless steel screen.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A softening-through-the-wash composition for dispensing in a wash cycle of a laundering process to provide softening of fabrics in the wash cycle or during a subsequent rinse cycle, the composition comprising:
(a) a particulate fabric softening active having an average particle size of less than about 800 microns in diameter; and
(b) optionally, a particulate co-softening compound having an average particle size of less than about 800 microns in diameter;
wherein the composition comprises an effective amount of the particulate fabric softening active and the optional particulate co-softening compound to provide a concentration of the particulate fabric softening active and the optional particulate co-softening compound of at least about 50 parts per million when the composition is dispensed in a wash solution of the laundering process; wherein the composition is substantially free of detersive surfactant and silicone material; and provided that when the composition comprises a montmorillonite clay, the composition is substantially free of a fatty alcohol or pentaerythritol compound.

2. The composition of claim 1, wherein the composition comprises from about 40% to about 95%, by weight of the composition, of the particulate fabric softening active.

3. The composition of claim 1, wherein the particulate fabric softening active is selected from the group consisting of ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)-2-hydroxyethyl ammonium methyl sulfate, methyl bis(hydrogenated tallow amidoethyl)-2-hydroxyethyl ammonium methyl sulfate, methyl bis (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

4. The composition of claim 1, wherein the composition comprises from about 5% to about 60%, by weight of the composition, of the particulate co-softening compound.

5. The composition of claim 4, wherein the co-softening compound is a fatty acid selected from the group consisting of stearic acid, palmitic acid, and mixtures thereof.

6. The composition of claim 1, wherein the composition further comprises a clay.

7. The unit dose composition of claim 6, wherein the clay is selected from the group consisting of a montmorillonite clay, a hectorite clay, and mixtures thereof.

8. The composition of claim 1, wherein the particulate fabric softening active and the particulate co-softening compound are both present in the composition as a mixture within the same particulates.

9. The composition of claim 1, wherein the composition further comprises a disrupting agent.

10. The composition of claim 9, wherein the disrupting agent is a mixture of sodium carbonate and citric acid.

11. The composition of claim 1, wherein the composition further comprises a perfume.

12. The composition of claim 1, wherein the composition comprises the co-softening compound and further comprises a clay; wherein the co-softening compound is a fatty acid; and wherein the particulate fabric softening active is selected from the group consisting of:
(a) a particulate fabric softening active having the formula:
[R¹C(O)OC₂H₄]ₘN⁺(R)₄₋ₘX⁻
wherein each R¹ is a C₆-C₂₂ hydrocarbyl group, having an Iodine Value of from 0 to about 140 based upon the Iodine Value of an equivalent fatty acid; m is from 1 to 3; each R is a C₁₋₃ alkyl or hydroxy alkyl group; the total of m and the number of R groups that are hydroxyethyl groups equaling 3; and X⁻ is a softener compatible anion;
(b) a reaction product of an alkylamine and a fatty acid; and
(c) mixtures thereof.

13. The composition of claim 1, wherein the composition is contained in a water-soluble film.

14. The composition of claim 13, wherein the water-soluble film comprises a polyvinyl alcohol.

15. The composition of claim 1, wherein the composition is compressed into a tablet.

16. The composition of claim 15, wherein the tablet comprises an outer layer comprising a coating material; wherein the outer layer has a thickness of less than about 1 millimeter.

17. The composition of claim 16, wherein the coating material is selected from the group consisting of polyethylene glycol, adipic acid, and mixtures thereof.

18. The composition of claim 16, wherein said outer layer further comprises a dye.

19. The composition of claim 16, wherein the coating material comprises a polyvinyl alcohol.

20. A process for manufacturing a softening-through-the-wash composition comprising a particulate fabric softening active, the process comprising the steps of:
(a) applying heat and/or pressure to the softening-through-the-wash composition; and
(b) forming particles having an average diameter of less than about 800 microns from the softening-through-the-wash composition using a technique selected from the group consisting of extrusion, prilling, agglomeration, and combinations thereof.

21. The process of claim 20, wherein the process further comprises the step of adding a particulate co-softening compound having an average particle size of less than about 800 microns in diameter to the formed particles; wherein the particulate co-softening compound is a fatty acid.

22. The process of claim 20, wherein the composition further comprises a particulate co-softening compound; wherein the particulate co-softening compound is a fatty acid; and wherein the formed particles comprise a mixture of the fabric softening active and particulate co-softening compound.

23. The process of claim 20, wherein the process further comprises the step of containing the formed particles in a water-soluble film.

24. The process of claim 20, wherein the softening-through-the-wash composition further comprises a clay, a disrupting agent, or mixtures thereof.

25. The process of claim 20, wherein the process further comprises the step of compressing the formed particles into a tablet.

26. The process of claim 25, wherein the process further comprises the step of coating the tablet to form an outer layer comprising a coating material.

27. The process of claim 26, wherein the coating material is selected from the group consisting of polyethylene glycol, adipic acid, and mixtures thereof.

28. The process of claim 26, wherein the outer layer further comprises a dye.

29. The process of claim 26, wherein the coating material comprises a polyvinyl alcohol.
